(19) United States
(12) Patent Application Publication
(10) Pub. No.: US 2008/0216096 A1
(43) Pub. Date: Sep. 4, 2008

(54) Virtual Computer System Supporting Trusted Computing and Method for Implementing Trusted Computation Thereon

(75) Inventor: Wanding Wang, Beijing (CN)

Correspondence Address: DICKSTEIN SHAPIRO LLP, 1177 AVENUE OF THE AMERICAS (6TH AVENUE), NEW YORK, NY, 10036-2714, US

(73) Assignee: Lenovo (Beijing) Limited, Beijing (CN)

(21) Appl. No.: 11/995,815

(22) PCT Filed: Mar. 24, 2006
(86) PCT No.: PCT/CN2006/000497

§ 371 Date: Mar. 20, 2008

(30) Foreign Application Priority Data
Jul. 15, 2005 (CN) 200510084208.7

(51) Int. Cl. G06F 9/46

(52) U.S. Cl. 719/319

(57) ABSTRACT

A virtual machine system supporting trusted computing includes a virtual machine monitor, a hardware and multiple operating systems (OSs). Said multiple OSs include at least a trusted OS, and at least a distrusted OS, a redirecting pipe is set in the virtual machine monitor, the redirecting pipe is adapted to redirect an I/O instruction from the distrusted OS to the trusted OS. Wherein, the trusted OS checks the trusted degree of a procedure information of the distrusted OS, and sends to the hardware an I/O instruction that corresponds to trusted procedure information confirmed via the trusted degree check, transferred via the redirecting pipe and came from the distrusted OS, performs an I/O operation by the hardware.

### BACKGROUND OF THE INVENTION

1. Field of Invention

The present invention relates to a virtual computer system and a trusted computing method, particularly to a virtual computer system supporting trusted computing and a method for implementing trusted computation thereon.

2. Description of Prior Art

Generally in the current computer system architecture, all types of Operating Systems (OSs) may run on one computer. Therefore, software procedures running on the OS may access hardware resources on the computer arbitrarily, such as reading data in a memory, modifying data on a hard disk, etc. This kind of fully-opening architecture has caused a large number of information security problems, including well-known viruses and network frauds. Therefore, some improved architectures and techniques have been developed in order to enhance the information security on the computer.

One exemplary technique is to develop an anti-virus software and install it on the computer for prevent and clear computer viruses. Conventional anti-virus software is compiled according to the idea of a virus technique and is capable of identify and clear computer viruses. However, venomous computer users compile new viruses continuously according to loopholes of the computer system. Meanwhile, old viruses are varying continuously. These old and new viruses damage the usage of the computer badly. Based on an undercount, viruses currently recorded in the computer viruses database have gone beyond 10 thousand pieces. This causes the anti-virus software is tired to deal with the viruses, also causes the anti-virus software much larger which wastes computer system resources dramatically when running. In fact, during the use of computer, the number of available trusted applications is relatively small. It is very considerable to reach 1000 such applications. However, such a small number of trusted applications have to prevent a large quantity of computer viruses which are still increasing. This leads to a significant problem to be solved urgently during the usage of the computer.

Therefore, in order to solve the problem of secure usage of the computer radically, a computer architecture system supporting trusted computing is proposed. The basic idea of the computer architecture system is: firstly a trusted degree for an application software is checked before the application software is running on a computer; when the application software is assured by the computer OS to be a trusted secure application software, the computer OS accepts and runs the application software on the computer, otherwise rejects to run the application software on the computer.

In a trusted computing architecture proposed by Trusted Computing Group (TCG), one Trusted Platform Module (TPM) chip is added to an LPC bus of a mainboard. This chip is used for the basis to check trusted degrees of other software modules on the computer. Firstly, it is checked whether BIOS integrity has been changed. Then, it is checked whether Master Boot Record (MBR) integrity has been changed. Next, it is checked whether Operating System Kernel (OSK) integrity has been changed. Finally, it is checked whether the integrity of upper-level application software has been changed. This approach may assure the computer always running in a certain trusted state, which, however, has not provided a simply feasible way on how to determine which new procedures are trusted procedures. Furthermore, since OSK is required to be modified, such a trusted computing architecture could not be implemented without a large variation to the current OS.

The CN patent application No. 200410056423.1 from Microsoft Inc. discloses a NGSCB (Next Generation Secure Computing Base) trusted computing architecture in its next generation OS. This trusted computing architecture divides a procedure into a protected procedure and a general procedure by means of a TPM and CPU and Chipsets isolation computing instructions on a mainboard. For the protected procedure which will run in a protected memory, it is difficult for such a venomous program to damage the protected procedures. This kind of architecture is suitable for improving network application security, especially when a user is making an online transaction using his PC. However, this kind of architecture substantially builds up a trusted computing area in one and the same CSK. Thus, in principle on the architecture, a security loophole of OS itself would affect security of the trusted computing area. Meanwhile, this architecture also needs to modify CSK, is not easy to upgrade and update, and couldn't be suitable for the rapidly increasing development of the computer, which could always not protect a new program.

To solve the above problems, a virtual machine platform technique is considered to be used.

Currently, exemplary virtual machine architecture comprises VT-i and VT-x techniques from Intel. The VT-x technique is a virtualized technique applicable on a desktop computer and a X86 server platform, and the VT-I is a virtualized technique applicable on a Itanium platform. Moreover, there is a Pacifica virtualized technique from AMD.

As shown in FIG. 1, in the current disclosed virtual machine architecture, a key point is to implement virtualization for hardware resources, so that a plurality of OSs may run on one computer in parallel. FIG. 1 shows OS1 and OS2, which is only illustrated as an example and the number of OSs is not limited to 2. Since these OSs do not interfere with each other (for example, OS2 may not access a memory which may be accessed by OS1), this architecture may also implement isolation between a plurality of OSs.

In this virtual machine architecture, a Guest OS may run on the virtual machine architecture without any modification by adding a set of instructions dedicated for a Virtual Machine Monitor (VMM), a virtual computing resource, a storage resource and an I/O resource on actual hardware level. This provides a very wide application scope, in which a general Guest OS may comprise Windows98, Windows2000, WindowsXP, Linux, Unix, Mac, etc.

However, the virtual machine architecture as shown in FIG. 1 has not implement a trusted-degree check for a procedure in a certain Guest OS when the procedure accesses the hardware resource. Thus, a venomous procedure may access the hardware resource directly via an I/O instruction, or even damage the hardware resource, for example, clear data on the hard disk etc.

Moreover, from the perspective of the development trend of the computer chip technique, visualization is an important trend for a future computer development, irrespective of Intel, AMD or other chip manufactures. That is to say, in this trend, almost all computers to be saled in the market in the future will support the virtual machine architecture. How to implement a trusted computing on the virtual machine platform technique architecture becomes a hot spot studied in this field.

### SUMMARY OF THE INVENTION

Accordingly, one of objects of the present invention is to provide a virtual machine system supporting trusted computing, which may radically enhance information security for using a computer without additional hardware cost.

Another object of the present invention is to provide a method for implementing trusted computing, which may radically enhance information security for using a computer.

According to a first aspect of the present invention, a virtual machine system supporting trusted computing is provided, which comprises a virtual machine monitor, a hardware and multiple OSs. The multiple OSs include at least a trusted OS, and at least a distrusted OS, a redirecting pipe is arranged in the virtual machine monitor, the redirecting pipe is adapted to redirect an I/O instruction from the distrusted OS to the trusted OS. Wherein, the trusted OS checks a trusted degree of procedure information from the distrusted OS; sends to the hardware an I/O instruction that corresponds to trusted procedure information confirmed via the trusted degree check, transferred via the redirecting pipe and came from the distrusted OS; and performs an I/O operation by the hardware.

According to a second aspect of the present invention, a method for implementing trusted computing is provided, which comprises the steps as follows:

at step 1, a distrusted OS sends an I/O instruction and procedure information;
at step 2, a virtual machine monitor captures the I/O instruction and redirects it to a trusted OS via a redirecting pipe;
at step 3, the trusted OS checks a trusted degree of the received procedure information, sends to a hardware an I/O instruction that corresponds to trusted procedure information confirmed via the trusted degree check, and performs an I/O operation by the hardware.

Compared with the prior art, the beneficial effect of the present invention is: since a procedure filtering module and a trusted procedure library are provided by the present invention to check the trusted degree of procedure information from a distrusted OS, a venomous procedure may be prevented from accessing and damaging the hardware resource. Furthermore, the present invention is easy to be implemented on the current hardware resource without additional hardware costs.

### BRIEF DESCRIPTION OF THE DRAWINGS

FIG. 1 is an illustrative block diagram of a virtual machine architecture in the prior art;

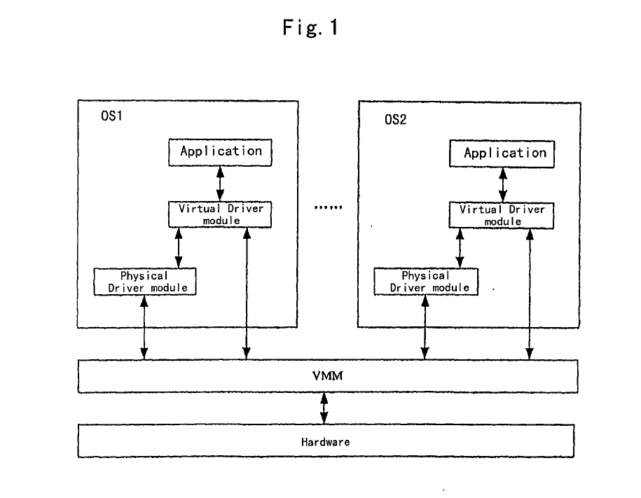

FIG. 2 is an illustrative block diagram of a virtual machine system supporting trusted computing according to the present invention;

FIG. 3 is a flowchart of implementing trusted degree check on procedure information and performing an I/O operation on the virtual machine system as illustrated in FIG. 2; and

FIG. 4 is a schematic view for designing an information storage area of a shard memory as illustrated in FIG. 2.

### DETAILED DESCRIPTION OF PREFERRED EMBODIMENTS

Hereinafter, a virtual computer system supporting trusted computing and a method for implementing trusted computation on the virtual computer system supporting trusted computing according to the present invention will be further described in detail by referring to the drawings.

### A First Embodiment

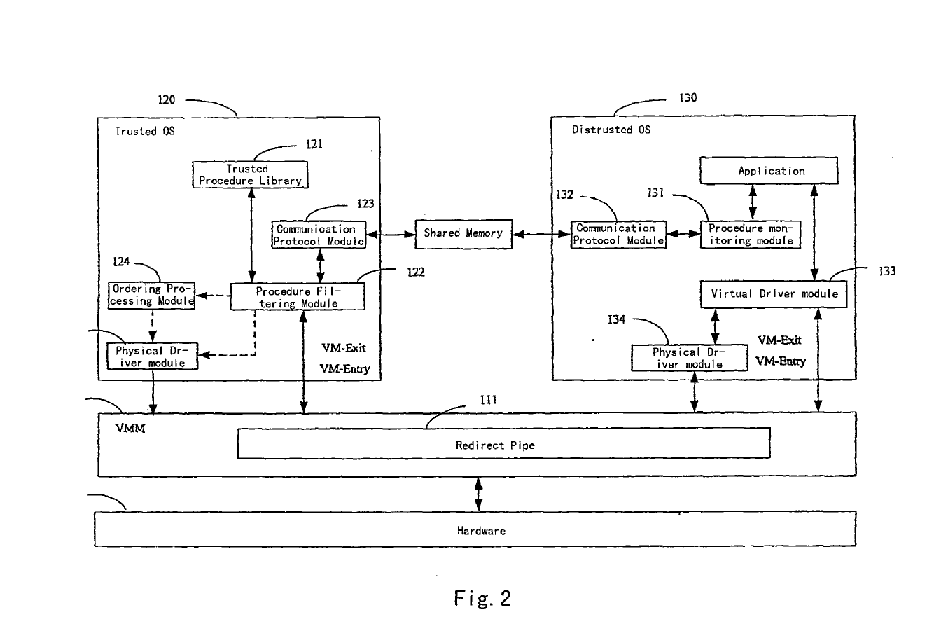

An illustrative block diagram of a virtual machine system supporting trusted computing according to the first embodiment of the present invention is shown in FIG. 2. In FIG. 2, the virtual machine system supporting trusted computing comprises a hardware 100, a virtual machine monitor 110 and a plurality of OSs running thereon. For convenience of the description, two OSs is illustrated as an example. In these two OSs, one OS is a trusted OS 120, and the other OS is a distrusted OS 130. The distrusted OS 130 is controlled by a user, runs an application needed to be performed by the user. The trusted OS 120 runs in the virtual machine system background. The virtual machine system always has the trusted OS 120, which may be one or more. The number of the distrusted OS 130 may be varied as required by the user, and the distrusted OS 130 may be installed in the virtual machine system.

The hardware 100 is the hardware on the current computer system, which comprises a processor, a memory, an I/O device, a PCI device and other devices.

The virtual machine monitor 110 runs between the upper-level OS and the bottom hardware, monitors all the operation requests (e.g. I/O instructions etc.) for hardware system resources and redirects all the operation requests for hardware resources to the trusted OS 120. The virtual machine monitor 110 comprises a virtual processor, a virtual memory, a virtual I/O device, a virtual PCI device, and other virtual devices. Compared with the current virtual machine monitor, a redirect pipe 111 is added to the virtual machine monitor 110. The redirect pipe 111 may redirect I/O instructions from the distrusted OS 130 to the trusted OS 120.

The trusted OS 120 comprises a trusted procedure library 121, a procedure filtering module 122, a communication protocol module 123, a virtual driver module 124 and a physical driver module 125. Procedure information of an existed trusted application is stored in the trusted procedure library 121. The procedure information is used for determining whether the procedure information from the distrusted OS 130 is trusted procedure information.

The distrusted OS 130 comprises a procedure monitoring module 131, a communication protocol module 132, a virtual driver module 133 and a physical driver module 134. An application running on the distrusted OS 130 is a new application which has not been via a trusted degree check, here is assumed to be a distrusted program.

The communication protocol employed on the above communication protocol modules 124 and 132 may be a TCP/IP protocol, because separate IP addresses may be allocated to the trusted OS and the distrusted OS when a system is installed.

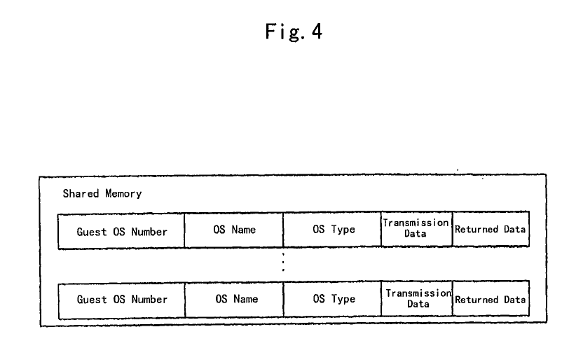

The communication protocol employed on the above communication protocol modules 124 and 132 may also be a simplified communication protocol. In the simplified communication protocol, various distrusted OSs may be distinguished by marked with serial numbers respectively. The virtual machine monitor 110 may partition a memory into such a shared memory as illustrated in FIG. 4 in advance for communication between OSs. Contents corresponding to various distrusted OSs (guest OSs) are arranged in the shared memory, i.e. information such as a guest OS serial number, an OS name, an OS type, transmission data and returned data, etc. Then, information sent from an opposing party is read from the shared memory area by means of a periodical querying mechanism between communication protocol modules in the different OSs.

In particular, when the distrusted OS needs to transmit parameters or data to the trusted OS, the communication protocol module will store these parameters or data in a “transmission data” area. The communication module in the trusted OS periodically checks whether there is new transmission data in the “transmission data” area, then reads the transmission data. When the trusted degree check result is needed to be fed back by the procedure filtering module in the trusted OS to the distrusted OS, the result is stored in a “returned data” area by the communication protocol module of the distrusted OS. Likewise, the communication module in the distrusted OS would check periodically whether there is new returned data in the returned data” area, then reads the returned data.

In the virtual machine system of the present invention, when the distrusted OS 130 executes applications, their procedures are distrusted procedures since these applications are distrusted programs. To prevent the virtual machine system from venomous procedures, the trusted degree check is needed to be preformed to the procedure information from the distrusted OS 130 by the trusted OS 120 before the distrusted procedures access the hardware 100 via an I/O instruction. Only if the procedure information is determined to be trusted procedure information by the trusted OS 120, the hardware 100 performs the I/O instruction corresponding to the distrusted procedures determined to be trusted procedures and completes the I/O operation. Thus, the hardware 100 is protected from venomous procedures.

In the current virtual machine system, the processor of the virtual machine monitor has two sets of computing instructions. One set is a Root instruction, containing a VM-Entry instruction which is used by the virtual machine monitor to give a control right to the specified OS; the other set is a Non-Root instruction, containing a VM-Exit instruction which is used by the OS to return the control right to the virtual machine monitor. Meanwhile, the virtual machine system defines respective Virtual-Machine Control Structure (VMCS) data structures for each OS. The VMCS is used for storing and resuming the state of the OS. The virtual machine monitor allocates spaces in the memory for each VMCS, and notifies the processor of an original address for the VMCS to be processed currently. When the virtual machine monitor 110 is required to give the control right to a certain OS, the virtual machine monitor 110 invokes the VM-Entry instruction (containing information corresponding to the VMCS for this OS), the processor would resume the state of the OS from the VMCS corresponding to this OS. When the OS is needed to access the hardware resource, the virtual driver module in the OS invokes the VM-Exit instruction, and the processor would store the state of the OS in the VMCS, meanwhile the virtual driver module returns the control right to the virtual machine monitor.

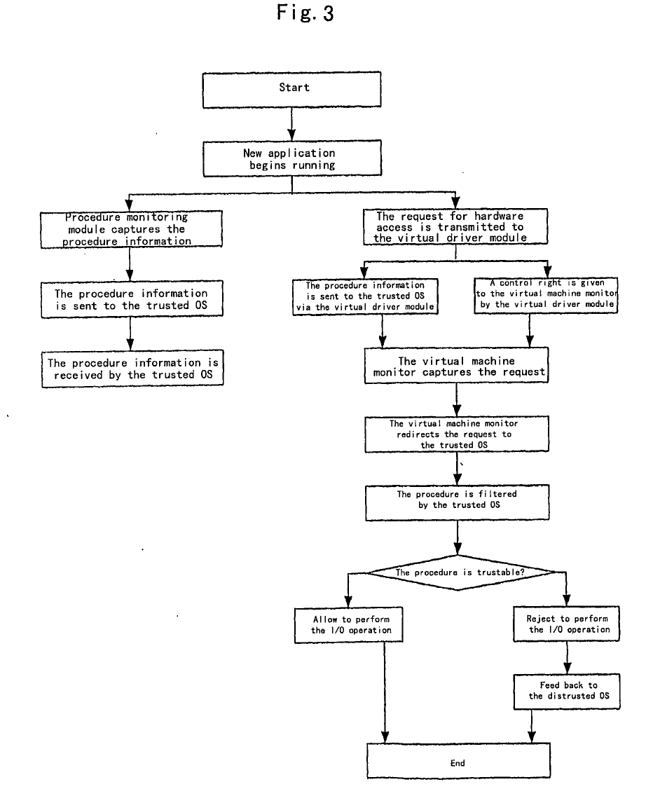

For convenience of further understanding the virtual machine system supporting trusted computing according to the first embodiment of the present invention, make reference to FIGS. 2 and 3, wherein, FIG. 3 is a flowchart for trusted degree check and I/O operation in the virtual machine system.

Firstly in the distrusted OS 130, when an application procedure is started, on one hand, the application procedure sends a request for hardware access. The request for hardware access is transmitted to the physical driver module 134 after it is received by the virtual driver module 133. Then, the physical driver module 133 converts the request for hardware access to the I/O instruction and sends it to the virtual machine monitor 110. Meanwhile, the virtual driver module 133 invokes the VM-Exit instruction so that the control right is given to the virtual machine monitor 110. The state of the distrusted OS 130 is stored in the VMCS corresponding to the distrusted OS 130 by the processor.

On the other hand, the procedure monitoring module 131 captures procedure information in the application procedure. The procedure information is transmitted to the shared memory (not shown) via the communication protocol module 132. As shown in FIG. 4, contents corresponding to the distrusted OS 130 are arranged in the shared memory, i.e. information such as a guest OS serial number, an OS name, an OS type, transmission data and returned data, etc. The procedure information is stored in the “transmission data” area corresponding to the distrusted OS in the shared memory.

Secondly in the virtual machine monitor 110, when the virtual machine monitor 110 captures the I/O instruction, it gives the control right to the trusted OS 120 by invoking the VM-Entry instruction so as to resume the state of the trusted OS 120 from the VMCS. Furthermore, the I/O instruction is sent to the procedure control module 122 of the trusted OS 120 by the virtual machine monitor 110 via the redirecting pipe 111. Then, a Procedure Guild is extracted from the I/O instruction by the procedure filtering module 122. According to the Procedure Guild, the procedure information stored by the distrusted OS 130 is obtained from the “transmission data” area in the shared memory via the communication protocol module 123.

Next, the procedure filtering module 122 determines whether the procedure information is trusted procedure information according to the procedure information of the trusted application stored in the trusted procedure library 121.

(1) If the procedure information is trusted procedure information, the I/O instruction is sent to the physical driver module 125 by the procedure filtering module 122. The I/O instruction is transmitted to the hardware 100 by the physical driver module 125 via the virtual machine monitor 110, and the I/O operation is performed by the hardware 100. When there are a plurality of distrusted OSs, if I/O instructions from various distrusted OSs are needed to be executed, an ordering mechanism is required to be added to the trusted OS 120 (such as an ordering processing module 124 in FIG. 2) to perform ordering process for various I/O instructions and to send the I/O instructions sequentially to the physical driver module 125. Of course, when there is only one distrusted OS, the I/O instructions may also be sent to the physical driver module 125 via the ordering processing module 124.

Finally, these I/O instructions are executed by the hardware 100 sequentially.

(2) If the procedure information is determined to be distrusted procedure information, the procedure information determined to be distrusted procedure information is stored in the “returned data” area corresponding to the distrusted OS 130 in the shared memory by the procedure filtering module 122. Then, the information stored in the “returned data” area of the shared memory is obtained by the distrusted OS 130 via the communication protocol module 132, and the I/O operation is canceled.

### A Second Embodiment

A trusted degree check and an I/O operation performed to procedure information from a distrusted OS 130 by a trusted OS 120 on a virtual machine system are explained as described above. Since a general-purpose computer is generally equipped with an interface communicating with a LAN or WAN, the virtual machine system of the present invention may also implement a trusted degree check for procedure information from the distrusted OS of the internal or external network, and perform an I/O operation after the procedure information is determined to be trusted procedure information.

That is to say, the virtual machine system according to the present invention may be a network computer system comprising a local computer and a network computer. The local computer is of a virtual machine structure as illustrated in FIG. 2, on which a distrusted OS may be installed by a user of the local computer as required, or may not be installed. The network computer is a distrusted computer for the local computer, the OS installed on which is also a distrusted OS. The information related to the distrusted OS (just like the distrusted OS on the local computer) may be stored in a shared memory partitioned by the virtual machine monitor. The communication between the distrusted OS and the trusted OS and the virtual machine monitor may be implemented by a current communication protocol such as a TCP/IP protocol. Such an architecture is easy to be implemented based on the first embodiment according to the present invention for the skilled in the art.

The present invention may be applied to the field of business and consumer computers in order to improve the anti-attack capability of the computers. For example, when the technical solution according to the present invention is applied to the net-bar security management, it may reject Trojan horse programs from cracking the hardware protection function on the net-bar computers; on the other hand, it may reject Trojan horse programs from stealing a user's game account and a password so as to reduce the economy loss of the user significantly. When the technical solution according to the present invention is applied to the consumer computers, a procedure authentication server may be maintained on the Internet by a manufacturer, and a trusted procedure library may be updated and improved continuously by customer service in order to help the customers to defect the attack of hackers and viruses.

In the future multi-network convergence time, a mobile device such as a smart phone and a household electric appliance such as a digital TV will become more and more popular, the customers will have some key applications via the mobiles or the digital TV such as transaction on line etc. so as to cause more risks on information security to the customers. Therefore, the technical solution according to the present invention may protect radically the key applications from distrusted viruses and Trojan horse.

The above is only the preferred embodiments of the present invention and the present invention is not limited to the above embodiments. Therefore, any modifications, substitutions and improvements to the present invention are possible without departing from the spirit and scope of the present invention.

1. A virtual machine system supporting trusted computing, the system comprising a virtual machine monitor (110), a hardware (100) and multiple OSs, wherein
the multiple OSs include at least a trusted OS (120), and at least a distrusted OS (130); and
a redirecting pipe (111) is arranged in the virtual machine monitor (110), the redirecting pipe adapted to redirect an I/O instruction from the distrusted OS (130) to the trusted OS (120), wherein,
the trusted OS (120) checks a trusted degree of procedure information from the distrusted OS (130); and sends to the hardware (100) an I/O instruction that corresponds to trusted procedure information confirmed via the trusted degree check, and is transferred via the redirecting pipe (111) from the distrusted OS (130); and performs an I/O operation by the hardware (100).

2. The virtual machine system according to claim 1, wherein the distrusted OS (130) comprises a procedure monitoring module (131), a communication protocol module (132), a virtual driver module (133) and a physical driver module (134), wherein
the procedure monitoring module (131) is adapted for capturing procedure information of an application when the application runs on the distrusted OS (130), and sending the procedure information to the trusted OS (120) via the communication protocol module (132);
the virtual driver module (133) is adapted for obtaining a request for hardware access from the application, converting the request to an I/O instruction via the physical driver module (134) and sends it to the virtual machine monitor (110); and
the trusted OS (120) comprises a trusted procedure library (121), a procedure filtering module (122), a communication protocol module (123), a virtual driver module (124) and a physical driver module (125), wherein
the procedure filtering module (122) is adapted for determining whether procedure information received by the communication protocol module (123) is a trusted procedure according to a trusted procedure stored in the trusted procedure library (121),
when the procedure information is a trusted procedure, an I/O instruction is sent to the hardware (100) via the physical driver module (125), and the I/O operation is performed by the hardware (100),
when the procedure information is a distrusted procedure, the procedure information determined to be distrusted procedure information is sent to the distrusted OS (130) via the communication protocol module (123), and the I/O instruction is canceled by the distrusted OS (130).

3. The virtual machine system according to claim 1, wherein the trusted OS (120) further comprises an ordering processing module (124) for ordering I/O instructions from one or more distrusted OSs before the I/O instructions are performed.

4. The virtual machine system according to claim 3, wherein the distrusted OS (130) is an OS on a network computer which communicates with the trusted OS (120) via a TCP/IP protocol.

5. The virtual machine system according to claim 3, wherein a shared memory is arranged between the distrusted OS (130) and the trusted OS (120) for communication.

6. A method for implementing trusted computing on the virtual machine system according to claim 1, the method comprising:
a distrusted OS (130) sending an I/O instruction and procedure information;
a virtual machine monitor (110) capturing the I/O instruction and redirecting it to a trusted OS (120) via a redirecting pipe (111);
the trusted OS (120) checking a trusted degree of the received procedure information, sending to a hardware (100) an I/O instruction that corresponds to trusted procedure information confirmed via the trusted degree check, and performing an I/O operation by the hardware (100).

7. The method according to claim 6 further comprising:
when the procedure information is a distrusted procedure, sending the procedure information determined to be distrusted procedure information to the distrusted OS (130), and cancelling the I/O instruction by the distrusted OS (130).

8. The method according to claim 7 further comprising:
a procedure monitoring step for capturing procedure information of an application when the application runs on the distrusted OS (130) and sending the procedure information to the trusted OS (120); and
a hardware access request obtaining step for obtaining a request for hardware access from the application, converting the request to an I/O instruction and sends it to the virtual machine monitor (110).

9. The method according to claim 6 further comprising:
an ordering processing step for ordering I/O instructions from one or more distrusted OSs before the I/O instructions are performed.

10. The method according to claim 9, wherein communication between the distrusted OS (130) and the trusted OS (120) is via a TCP/IP protocol or a shared memory.

11. The virtual machine system according to claim 2, wherein the trusted OS (120) further comprises an ordering processing module (124) for ordering I/O instructions from one or more distrusted OSs before the I/O instructions are performed.

12. The method according to claim 7 further comprising:
an ordering processing step for ordering I/O instructions from one or more distrusted OSs before the I/O instructions are performed.

13. The method according to claim 8 further comprising:
an ordering processing step for ordering I/O instructions from one or more distrusted OSs before the I/O instructions are performed.
